(19) United States
(12) Patent Application Publication
(10) Pub. No.: US 2010/0009892 A1
(43) Pub. Date: Jan. 14, 2010

(54) Multi-function surfactant composition

(76) Inventor: Jennifer Hauke, Orlando, FL (US)

Correspondence Address: THE WEINSTRAUB GROUP, P.L.C., 28580 Orchard Lake Road, Suite 140, Farmington Hills, MI, 48334, US

(21) Appl. No.: 12/284,395

(22) Filed: Sep. 22, 2008

Related U.S. Application Data
(60) Provisional application No. 60/994,694, filed on Sep. 21, 2007.

(51) Int. Cl. C11D 17/08

(52) U.S. Cl. 510/433; 510/436

(57) ABSTRACT

A surfactant concentrate is provided an admixture of a phosphonated amphoteric surfactant and a fluorosurfactant. The phosphonated surfactant may be used alone or in admixture with a second phosphonated surfactant, an additional amphoteric surfactant or a Zwitterionic surfactant. The fluorosurfactant may be either anionic, nonionic, or mixtures thereof. The surfactant composition may be used to formulate either a highly caustic detergent concentrate or an acid cleaner. The surfactant concentrate and cleaner made therefrom have a variety of uses. A highly caustic cleaner prepared from a surfactant concentrate is particularly usable in the brewing industry.

### CROSS-REFERENCE TO RELATED APPLICATIONS

This application is a completion application of co-pending U.S. Provisional Patent Application No. 60/994,694, filed Sep. 21, 2007 for “CLEANING COMPOSITION,” the entire disclosure which is hereby incorporated by reference.

### BACKGROUND OF THE INVENTION

1. Field of the Invention

The present invention pertains to cleaning compositions. More particularly, the present invention relates to both alkaline and acidic cleaning compositions. Even more particularly, the present invention pertains to surfactant compositions useful in preparing alkaline cleaning compositions for use in breweries, dairies and other environments where either alkaline as well as acidic cleaners.

2. Description of the Prior Art

As is known to those skilled in the art to which the present invention pertains, the utilization of highly alkaline cleaning compositions such as used in breweries and like environments involve the deployment of caustic soda and/or other highly alkaline materials. Because of the low pH encountered in breweries and the like, the need for these highly alkaline caustic cleaners is necessary.

Typically, such highly alkaline compositions are surfactant-based and which are either soluble or rendered soluble in aqueous caustic environments. For example, in U.S. Pat. No. 6,277,801, the disclosure of which is hereby incorporated by reference, there is taught a mixture of an amphoteric surfactant and an oxyalkylated nonionic surfactant which is incorporated into a highly alkaline caustic cleaner through the utilization of a gluconate sequestrant. While the cleaner thereof is efficacious, the cost of the amphoteric surfactant is deleterious to overall economies of use.

Other prior art alkaline cleaners are disclosed in U.S. Pat. Nos. 6,555,511 and 6,855,679, the disclosures of which are hereby incorporated by reference. According to their teachings fluorinated surfactants are used in admixture with an amine-based sultaine amphoteric surfactant to provide a surfactant mixture which can be used with a caustic material to provide a highly alkaline cleaner. However, the cost of the amine-based amphoteric surfactant, again, renders it disadvantageous because of the cost associated therewith.

Thus, there exists a need to reduce the amount of amphoteric surfactant while still achieving the advantages of the fluorinated nonionic and anionic surfactants.

Furthermore, it would be highly desirable, if the amphoteric surfactant could be eliminated in toto while still providing an effective alkaline cleaner.

The present invention seeks to achieve the purposes hereof by providing a surfactant mixture which: (a) is more economical and which is useful in manufacturing a highly caustic cleaner and which shows particular efficacy in the cleaning of draft brewery lines, piping, dairies, bottle washing as well as in other hard surface environments as well as being useful in acidic cleaners, (b) can be used to prepare acid cleaners, and (c) exhibits efficacy in other manufacturing situations.

### SUMMARY OF THE INVENTION

In a first aspect hereof, there is provided a surfactant concentrate or composition for use in both a highly caustic alkaline clean as well as an acidic cleaner and which generally, comprises: a) an organic phosphated amphoteric surfactant and (b) a fluorinated surfactant. This admixture of surfactants is highly stable in both highly alkaline and acid environments.

The fluorinated surfactant may be either nonionic, anionic or mixtures thereof.

Other amphoteric surfactants can be used alone or in admixture. The phosphated amphoteric surfactants hereof can be used alone or in admixture with other amphoteric surfactants and/or Zwitterionic surfactants.

The mixture of phosphated amphoteric surfactant and fluorinated nonionic surfactant, generally, comprises from about zero parts to about 99 parts by weight and, preferably, from about 45 parts to about 96 parts by weight of the amphoteric surfactant and from about 1 part to about 55 parts by weight of the fluorinated surfactant, the balance being water and, preferably, deionized water.

The surfactant composition, as noted may be used to prepare an alkaline detergent concentrate which comprises: (a) a highly caustic cleaner selected from the group consisting of sodium hydroxide, potassium hydroxide and mixtures thereof, and (b) the surfactant composition.

An alkaline use solution is prepared by diluting the detergent concentrate with water in order to provide a form about a 0.5% to about a 5%, by volume, aqueous solution of the detergent concentrate.

In use, the sodium hydroxide or caustic soda is ordinarily deployed as a 50%, by weight, aqueous solution thereof and the potassium hydroxide is deployed as a 45% by weight aqueous solution thereof, which is then diluted with water to form an about 30% caustic detergent concentrate solution which is, then, further diluted to form an about 0.5% to an about 5.0%, by volume, use solution.

It is also possible, depending on the environment, to eliminate the amphoteric surfactant and to just increase the amount of the nonionic surfactant.

The fluorinated surfactant that is selected depends upon the desired foaming characteristics and can be selected to tailor the properties of the resulting solution. Thus, the fluorinated surfactant may be nonionic, anionic or mixtures thereof.

Other adjuvants may be incorporated into the composition such as other surfactants, descalers, foam suppressants, ph adjusters, ph buffers, stain and soil repellants, waxes, resins, polishes, abrasives, colloid stabilizers, auto control agents, dyes, fragrances, brighteners, anti-microbial agents, preservatives as well as mixtures thereof.

As noted hereinabove, the use solution has particular utility in the food and beverage industry and is particularly useful for cleaning hard surfaces, as well as being eminently useful in the cleaning of python tubing utilized in draft beer and beverage systems.

The surfactant composition may also be used to prepare acid cleaners by admixing same with an acid, such as a 85% aqueous phosphoric acid solution.

In addition, the present surfactant composition may be used as an emulsifier, solubilizer as well as a dispersant for keeping ordinarily insoluble particles in suspension.

For a more complete understanding of the present invention reference is made to the following detailed description and accompanying drawing and non-limitative example.

### BRIEF DESCRIPTION OF THE DRAWINGS

FIG. 1 is a graph illustrating the contact angles for a NaOH use solution on a polytetrafluoroethylene surface using a first use solution formulation hereof;

FIG. 2 is a second graph showing the contact angles for an NaOH use solution on the same surface using a second formulation hereof;

FIG. 3 is a third graph showing contact angles for an NaOH use solution on a polytetrofluoroethylene surface using a third formulation in accordance herewith, and,

FIG. 4 is a graph illustrating the contact angles for an NaOH use solution on a polytetrafluoroethylene surface using a fourth formulation in accordance herewith.

### DESCRIPTION OF THE PREFERRED EMBODIMENTS

As hereinabove noted, the present invention provides, in a first aspect, a surfactant detergent composition which evidences is particularly useful in the food and beverage industry and which is incorporated into and renders possible a highly caustic alkaline detergent which can be used to clean hard surfaces as well as python tubing.

The surfactant detergent composition hereof consists essentially of: (a) an organic phosphated amphoteric surfactant and (b) a fluorinated surfactant.

The phosphated amphoteric surfactants, as a class, provide excellent detergency in that they have dirt-lifting properties rendering them useful in hard surface cleaning and as well as having hydrotroping properties to enable the utilization and the incorporation of surfactants into aqueous-based systems when used in conjunction therewith. Also, the amphoteric surfactants elevate the cloud points of alkaline and highly built detergent systems to improve their detergency at higher operating temperatures. Furthermore, the amphoteric surfactants are, typically, stable across an entire pH range and have low, if no toxicity. Likewise, the amphoteric surfactants enable and provide surface tension reduction ordinarily associated with nonionic surfactants.

A particularly preferred phosphated amphoteric surfactant contemplated for use herein is that which is sold by DeForest Enterprises, Inc. under the name DeTeric CSP-50. This product is well-known and commercially available.

This particular amphoteric surfactant can be used alone or in admixture with other amphoteric and/or Zwitterionic surfactants. DeTeric CSP-50 is described as an organic phosphated amphoteric surfactant that is soluble and stable in both liquid caustic and liquid caustic potash. It is, also, described as a clear, substantially colorless liquid at 25° C. with about a 23% activity. The surfactant exhibits a pH of from about pH 9.0 to about pH 11.0. This surfactant is further indicated as being soluble in water, alcohol and glycol in 10%, by weight, solutions.

Representative of the other amphoteric surfactants which can be used in conjunction with the Deteric CSP-50 include, for example, alkylether hydroxy sultaines, imino diproprionate amphoteric surfactants fluoroamphoteric surfactant and the like as well as mixtures thereof.

Representative of the Zwitterionic surfactants that can be used are the secondary and tertiary amines, derivatives of quaternary ammonium, phosphonium or sulfonium compounds as well as the betaine and sultaine surfactants. These are all well known to those skilled in the art such as described in U.S. Patent Application Publication No. 2005/0282719, the disclosure of which is hereby incorporated by reference.

Similarly, amine oxide amphoteric surfactants as well as the alkyl amphocarboxylic surfactants can be used with the phosphated amphoteric surfactant.

Where used with the phosphated amphoteric surfactants, the additional surfactant(s) are present in a respective weight ratio of about 1:99 to about 99:1 and, preferably, from about 1:2 to about 2:1.

As noted, the second component of the surfactant detergent composition is a fluorinated surfactant. Useful fluorinated surfactants include both nonionic and anionic fluorosurfactants as well as mixtures thereof. Fluorinated nonionic and anionic surfactants are well-known and commercially available and can be chosen according to the desired foam properties.

Representative of the fluorinated surfactants contemplated for use herein are those sold by DuPont Chemical under the mark Zonyl. For example, Zonyl FSP is described as an anionic surfactant which exhibits anti-corrosive properties in acidic or alkaline media. This type of surfactant is a useful emulsifier and dispersant. Another useful fluorinated surfactant is the DuPont Zonyl FSN surfactant which is a low foaming fluorinated surfactant.

Other Zonyl-brand fluorinated surfactants contemplated for use herein include Zonyl FSJ, Zonyl FS-610, Zonyl FS-500 and Zonyl FSA, all of which are commercially available. Mixtures of these surfactants can be used.

As noted, mixtures of the nonionic and anionic fluorinated surfactants can be used, as well. Where a mixture of nonionic and anionic fluorosurfactants is used they are deployed in a weight ratio of from about 1:99 to about 99:1.

In preparing the surfactant composition, it is rendered as a concentrate comprising generally from about 0.0% to about 99.0% by weight of the amphoteric surfactant and, preferably, from about 45% to about 95% by weight of the amphoteric, based on the total weight of the concentrate.

The fluorinated surfactant is present in an amount ranging from about 0.02% to about 99%, by weight, based upon the total weight of a concentrate and, preferably, from about 2% to about 5%, by weight, based upon the total weight of the concentrate composition.

The balance of the surfactant concentrate mixture is, preferably, deionized water as well as any adjuvants.

Other components or adjuvants which may be incorporated include, for example, disinfectants as well as those enumerated below.

Generally, the adjuvants will comprise no more than about 15% by weight of the total surfactant concentrate.

The surfactant concentrate is prepared by admixing the two components together at ambient conditions. Otherwise, they can be individually admixed directly into a detergent concentrate, as described hereinafter.

In preparing a highly alkaline detergent concentrate, the surfactant concentrate is admixed with a highly caustic cleaner such as either liquid caustic soda or liquid potash. Typically, these two caustic materials are present as aqueous solutions thereof and, typically, a 50% aqueous solution of sodium hydroxide and/or 45% potassium hydroxide or potash is employed.

In preparing the highly alkaline detergent concentrate, the surfactant concentrate will be present in the caustic material in an amount ranging from about 0.5% to about 5%, by weight, based upon the total weight of the detergent concentrate. The concentrate is prepared by admixing the surfactant concentrate with the caustic material at ambient conditions.

As noted hereinabove, the present surfactant admixture can also be used to prepare an acid cleaner. Ordinarily, the surfactant mixture or concentrate and other adjuvants will be used in the same proportions as denoted above, i.e. no more than about 15%, by volume, of the concentrate.

A typical acid cleaner concentrate solution will comprise: (a) from about 25% to about 55%, by volume, of the acid, usually, a 75% phosphoric acid solution, (b) from about 0.1% to about 5.0%, by volume, of the surfactant mixture, (c) from about 30% to about 70%, by volume, of water, preferably, deionized water and, (d) the balance being the above-noted adjuvants. In preparing an acid cleaner use solution, the same volumetric ratios are employed as those employed in preparing the alkaline concentrate.

Where necessary, sequestrants such as the gluconate or phosphonate and, preferably, sodium gluconate may be used. Where used the gluconate will comprise from about 0.5% to about 2.0%, by weight, based on the total weight of the detergent concentrate.

In use, the caustic detergent concentrate is diluted with water either in a continuous system or by simply admixing it with water to provide an about 0.5% to about 5.0% caustic use solution.

It should further be noted that the final composition, be it alkaline or acid, can be rendered in tableted or powdered form by, preferably spray coating the surfactant composition onto powdered or flaked caustic or acid material which is then dried and compressed in a suitable die into the tableted form. Otherwise, the surfactant can be sprayed onto the caustic or powdered acid material and then powdered by any well-known and commercially available method, such as ball milling, or the like.

It is possible to incorporate colorants and dyes, which provide color indicators to ensure the fact that none of the cleaner remains either on the hard surface or in the python tubing.

For a more complete understanding of the present invention reference is made to the following illustrative examples.

### Example I

A surfactant concentrate was prepared by admixing together, at ambient conditions 95 parts of a phosphated amphoteric surfactant sold under the name DeTeric CSP and five parts of a nonionic fluorinated surfactant sold by DuPont chemical under the name Zonyl FS-610.

A 50% aqueous caustic soda solution which was then diluted to 30% with water to form a 30% NaOH-containing detergent concentrate.

Quantities of the surfactant concentrate were then added to the 30% caustic concentrate to prepare, respectively, a 1% by weight, a 2%, by weight and a 3%, by weight surfactant-containing detergent concentrate.

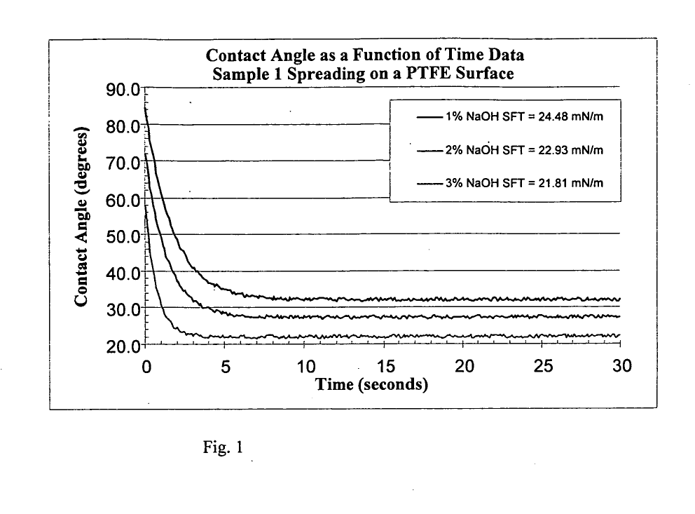

Each of the detergent concentrates were then tested for contact angle as a function of time data by taking a sample thereof and spreading it on a polytetrafluoro ethylene (PTFE) surface. The results of this are shown in FIG. 1.

Similarly, each of the three samples was tested for surface tension.

The results of this are shown in Table 1 below.

TABLE 1

| | | | 1% NaOH |
|---|---|---|---|
| | 3% NaOH Surface | 2% NaOH Surface | Surface Tension |
| Test # | Tension (mN/m) | Tension (mN/m) | (mN/m) |
| 1 | 21.80 | 22.94 | 24.47 |
| 2 | 21.82 | 22.92 | 24.48 |
| Average | 21.81 | 22.93 | 24.48 |

### Example II

Following the procedure of Example 1, a surfactant concentrate was prepared by admixing together 71 parts of the DeTeric CSP-50, 3-1/2 parts of Zonyl FS-610 and 25.5 parts of deionized water. The resulting compositions were then tested at various concentrations in the same manner described with respect to

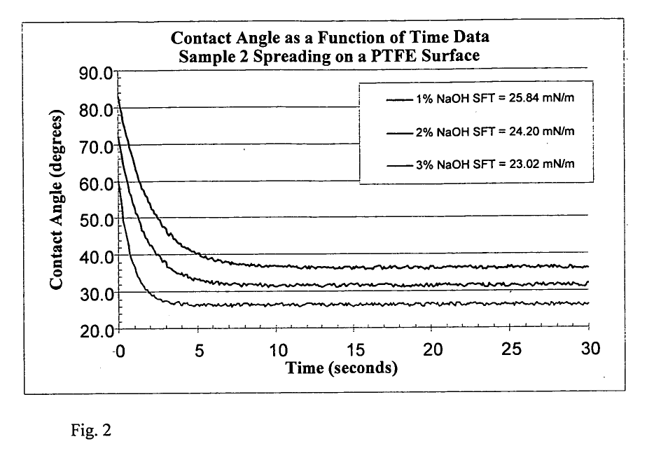

The results of the contact angle testing are shown in FIG. 2 and the results of the surface tension measurement are shown hereinbelow in Table 2.

TABLE 2

| | | | 1% NaOH |
|---|---|---|---|
| | 3% NaOH Surface | 2% NaOH Surface | Surface Tension |
| Test # | Tension (mN/m) | Tension (mN/m) | (mN/m) |
| 1 | 23.00 | 24.18 | 25.83 |
| 2 | 23.03 | 24.22 | 25.85 |
| Average | 23.02 | 24.20 | 25.84 |

### Example III

Example 1 was repeated but using a surfactant concentrate of 47.5 parts of the same phosphated amphoteric surfactant, 2.5 parts of the same nonionic surfactant and 50 parts of deionized water.

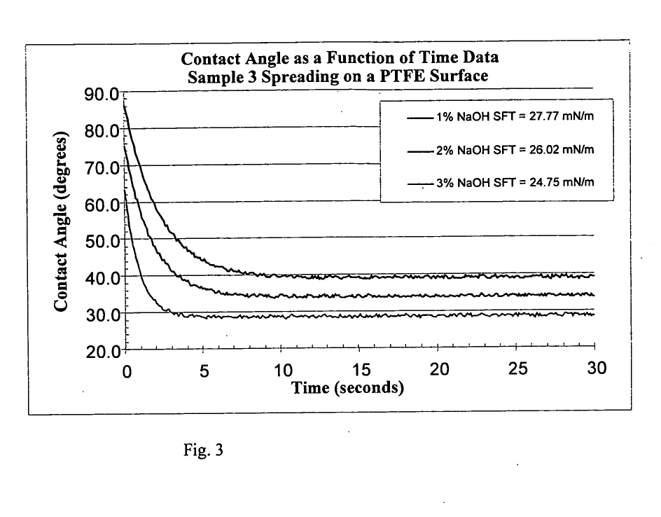

The results of testing are shown in FIG. 3 and in Table 3 below, respectively, for contact angle and surface tension measurements using 1%, 2% and 3% caustic soda detergent concentrates.

TABLE 3

| | | | 1% NaOH |
|---|---|---|---|
| | 3% NaOH Surface | 2% NaOH Surface | Surface Tension |
| Test # | Tension (mN/m) | Tension (mN/m) | (mN/m) |
| 1 | 24.77 | 26.03 | 27.76 |
| 2 | 24.73 | 26.00 | 27.78 |
| Average | 24.75 | 26.02 | 27.77 |

### Example IV

Following the procedure of Example 1 a surfactant concentrate was prepared for 47.6 parts of the same amphoteric surfactant, 4.8 parts of the same fluorinated surfactant and 47.6 parts of deionized water.

Each of the surfactant concentrates was then used to prepare, respectively, 1%, 2% and 30% caustic soda-containing detergent concentrates which were then measured for a contact angle and surface tension as described above.

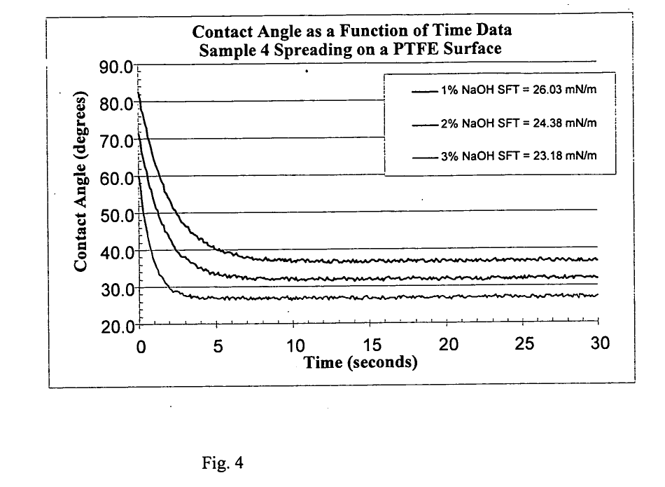

The results are shown, respectively, in FIG. 4 and Table 4 below.

TABLE 4

| | | | 1% NaOH |
|---|---|---|---|
| | 3% NaOH Surface | 2% NaOH Surface | Surface Tension |
| Test # | Tension (mN/m) | Tension (mN/m) | (mN/m) |
| 1 | 23.16 | 24.38 | 26.04 |
| 2 | 23.19 | 24.37 | 26.01 |
| Average | 23.18 | 24.38 | 26.03 |

In preparing the final use solution, it is preferable, to admix the resulting detergent concentrate and the sequesterant in the amounts indicated above.

From the above, it is readily apparent that the present invention provides a more economical, highly caustic cleaning composition having particular utility in the draft line and brewery industry but which is amenable to cleaning all hard surfaces in the food and beverage industry.

In addition to the surfactant composition hereof being efficacious in the food and beverage industry, it has now been found that the surfactant composition hereof can be used in industrial cleaner formulations, in coatings for metals and paper, as a dispersant, as well as a detergency application.

For example, because the amphoteric surfactant utilized herein reduces the surface tension of a liquid, it can be utilized, in conjunction with the fluorosurfactant as a solublizer. The phosphated amphoteric surfactant causes critical micelle concentration. Since micelles are water soluble, aggregates of surfactant molecules which have hydrophobic inner cores in which normally insoluble material can reside and stay water soluble. The micelles only develop beyond a certain concentration of a surfactant and solution.

The phosphated amphoteric surfactant also enables the detergent concentrate hereof to function as an emulsifier for two or more immiscible fluids.

In addition, and as noted, the surfactant composition hereof can also be used as a dispersant in the pulp and paper industry because of the ability of the amphoteric surfactant to keep insoluble particles in suspension. Thus, in dealing with pulp and paper as well as phthalo coatings and pigment dispersions, the amphoteric surfactant surrounds and coats the pigment particles causing them to repel one another. This repulsion provides increased stability to the dispersion. Furthermore, the ability of the amphoteric surfactant to trap or destroy a contaminant so that it stays in solution prevents its redeposition as the solution is removed.

From the above, it is readily perceived that the present invention provides a highly utilitarian surfactant concentrate.

Having, thus, described the invention, what is claimed is:

1. A multi-functional surfactant concentrate comprising:
(a) a phosphated amphoteric surfactant,
(b) a fluorinated surfactant, and
(c) water.

2. The concentrate of claim 1 which comprises:
(a) from about 0.0% to about 99.0% by weight, of the amphoteric surfactant, based on the total weight, and
(b) from about 0.2% to about 99.0%, by weight, of the fluorinated surfactant, based on the total weight.

3. The concentrate of claim 2 wherein:
(a) the phosphated surfactant is present in an amount ranging from about 45.0% to about 95.0%, by weight, based on the total weight of the concentrate, and
(b) the fluorinated surfactant is present in an amount ranging from about 2.0% to about 5.0%, by weight, based on the total weight of the composition.

4. The concentrate of claim 1 which further comprises:
a second amphoteric surfactant selected from the group consisting of alkyl ether hydroxy sultaines, imino dipropronates, and mixtures thereof, the second amphoteric surfactant being present in the concentrate in a weight ratio of from about 1:99 to about 99:1 with respect to the phosphated amphoteric surfactant.

5. The concentrate of claim 1 which further comprises:
a Zwitterionic surfactant selected from the group consisting of:
secondary amine surfactants, tertiary amine surfactants, quaternary ammonium derivatives, phosphonium derivatives, sulfonium derivatives, and mixtures thereof,
the Zwitterionic surfactant being present in an amount ranging from about 99:1 to about 1:99, by weight, with respect to the phosphated amphoteric surfactant.

6. The concentrate of claim 1 which further comprises:
a second amphoteric surfactant selected from the group consisting of alkyl ether hydroxy sultaines, imino diproprionates, and mixtures thereof, the second amphoteric surfactant being present in the concentrate in a weight ratio of from about 1:99 to about 99:1 with respect to the phosphated amphoteric surfactant,
a Zwitterionic surfactant selected from the group consisting of:
secondary amine surfactants, tertiary amine surfactants, quaternary ammonium derivatives, phosphonium derivatives, sulfonium derivatives, and mixtures thereof,
the Zwitterionic surfactant being present in an amount ranging from about 99:1 to about 1:99, by weight, with respect to the phosphated amphoteric surfactant.

7. The concentrate of claim 1 wherein:
the fluorinated surfactant is selected from the group consisting of anionic fluorinated surfactants, nonionic fluorinated surfactants and mixtures thereof.

8. The concentrate of claim 8 which comprises:
a mixture of nonionic and cationic fluorinated surfactants, the mixture being present in the concentrate in a respective weight ratio of from about 1:99 to about 99:1.

9. A detergent concentrate comprising:
an effective amount of the surfactant concentrate of claim 1.

10. The detergent concentrate of claim 9 which further comprises:
a caustic cleaner selected from the group consisting of liquid caustic soda, liquid potash and mixtures thereof, the caustic cleaner being present as a 50% aqueous caustic soda solution, a 45% aqueous potash solution and mixtures thereof.

11. The detergent concentrate of claim 10 which further comprises:
from about 0.5% to about 5.0%, by weight, of the surfactant concentrate, based on the total weight of the detergent concentrate.

12. The detergent concentrate of claim 9 which further comprises:
from about 25% to about 55%, by volume, based on the total volume, of an acid cleaner.

13. The detergent concentrate of claim 12 wherein the acid cleaner is a 75% phosphoric acid solution.

14. The detergent concentrate of claim 13 wherein the surfactant concentrate is present in an amount ranging from about 0.1% to about 4% by volume, based on the total volume.

15. The detergent concentrate of claim 14 which further comprises:
a gluconate or phosphonate sequestrant, the sequestrant being present in an amount less than about 15% by volume, based on the total volume, the balance of the concentrate being water.
